(19) United States
(12) Patent Application Publication
(10) Pub. No.: US 2024/0284922 A1
(43) Pub. Date: Aug. 29, 2024

(54) VISION-BASED QUALITY CONTROL AND AUDIT SYSTEM AND METHOD OF AUDITING, FOR CARCASS PROCESSING FACILITY

(71) Applicant: Jarvis Products Corporation, Middletown, CT (US)

(72) Inventors: Reed Jarvis, Middletown, CT (US); Shengxiang Jiang, Glastonbury, CT (US)

(21) Appl. No.: 18/588,571

(22) Filed: Feb. 27, 2024

Related U.S. Application Data
(60) Provisional application No. 63/448,877, filed on Feb. 28, 2023.

(51) Int. Cl. A22C 17/00

(52) U.S. Cl. CPC A22C 17/008

(57) ABSTRACT

A carcass processing system having a method and apparatus for monitoring the quality of processing carcasses manually or automatically (robotically) by implementing a vision-based architecture, incorporating machine learning and/or artificial intelligence (AI) and empirical data analysis forming a vision-based quality control and audit system, and method of performing the same, for the purpose of performing quality cutting of the carcasses, and making adjustments to the cutting apparatus during processing.

### BACKGROUND OF THE INVENTION

### 1. Field of the Invention

This invention relates to carcass processing systems, both manually and automatic, in which a mechanism is situated for splitting or removing a portion of the carcass as it is supported on a carcass rail in a carcass processing facility. Specifically, the invention relates to a method and apparatus for monitoring the quality of processing suspended carcasses manually or automatically (robotically) as the carcass is moved along a defined path. More specifically, the invention implements a machine vision architecture, incorporating machine learning and/or artificial intelligence (AI) and data analysis to develop a state-of-the-art vision-based quality control and audit system, and method of performing the same, for the purpose of providing consistent information on the quality of product generated from the manual or automatic (robotic) process, such that plant-to-plant and auditor-to-auditor variabilities are minimized.

### DESCRIPTION OF RELATED ART

Meat processors have long worked to optimize their operations. Historically a cyclical business characterized by lean margins, meat processors find it necessary to keep costs low and optimize profit per animal harvested to remain viable.

The meat-processing industry consists of establishments primarily engaged in the slaughtering of different animal species, such as cattle, hogs, sheep, lambs, or calves, for obtaining meat to be sold or to be used on the same premises for different purposes. Processing meat involves slaughtering animals, cutting the meat, inspecting it to ensure that it is safe for consumption, packaging it, processing it into other products (e.g., sausage, lunch meats), delivering it to stores, and selling it to customers.

Slaughtering animals mechanically has become a widespread phenomenon in many abattoirs, plants, and firms in a number of countries. The idea and objective behind slaughtering animals mechanically (i.e., via automation) rather than manually is to speed up the process of slaughter, thus catering for a mass production. And presumably, enable a slaughtering process with a more consistent and accurate cutting profile.

Remote monitoring of the slaughtering process is innovative technology for meat processors. The benefits are numerous, including better yields as a result of consistent information on quality being accessible, which ultimately leads to increased profits, less raw material waste due to product consistency, energy savings, improved worker safety and reduced liability.

A robotic carcass processing system typically employs a robotic arm having multiple axes of motion, an end effector, such as a saw or cutter, mounted thereon, and a controller. The controller is generally designed to move the end effector in Cartesian space via inverse kinematics with interpolation control over the multiple axes of the robotic arm to synchronously move the end effector relative to a carcass on an assembly line. The controller also determines when the robotic arm has moved its end effector out of a defined space to indicate that space is clear and to permit the other robotic arm to enter that space. The controller sends a signal to the robotic arms to either effect a standard cut or to modify the standard cut at the identified location or carcass.

Current vision-based sensor systems detect the tail bone location on the supported beef carcass in Cartesian coordinates as the supported beef carcass moves along the carcass rail. Such a system is taught in U.S. Pat. No. 9,955,702 issued to Jarvis Products Corporation, titled “Beef Splitting Method and System.” The vision-based sensor system does not perform quality control functions.

A robot-based carcass processing device may be disposed on a table, the table moving synchronously with each supported carcass while the carcass is split. The splitting saw may be a band saw. The splitting saw may be counterbalanced by a mass having a weight less than the weight of the splitting saw to permit up or down movement of the saw by the robotic arm of the robot-based carcass processing device using a force less than the weight of the splitting saw. The carcass has a front side and a back side and the carcass may be supported on the carcass trolley with the back side facing toward the robot-based carcass processing device and the front side facing away from the robot-based carcass processing device.

The slaughter of livestock involves three distinct stages: preslaughter handling, stunning, and slaughtering. Slaughtering relies on precise cutting of the carcass at various intervals of processing.

For example, in U.S. hog carcass processing facilities, it is common for the head of the animal to remain attached to one side of the carcass. It is important that the backbone be fully severed while at least a portion of the back strap adjacent to the backbone be maintained intact so that the supporting structure not become unbalanced. In European-style processing, where the severed head is held to the carcass by jowls on both sides, it is important that the backbone splitting end effector not cut into or nick the head, to avoid unwanted damage. Timely manual adjustments must often be made to the depth and stroke of the splitting end effector in either system to ensure that problems are corrected, or advantageously, do not occur.

Processing steps that rely heavily on manual execution can be resource intensive, and can introduce a high rate of variability. It is important that accurate and precise cuts be made. Thus, the precision and quality of each cut is indicative of a consistent, repeatable process.

Generally, carcasses are cleaned and opened to remove internal components, and then split down the center of the spine or backbone into two sides, which are subsequently further processed into meat cuts. Meat processing facilities typically operate on carcasses that continuously move along an overhead carcass rail. Each carcass is suspended from a supporting structure or rack that rides along the overhead carcass rail or track. Trolleys are driven typically by a chain so that each carcass moves past each processing station at a predetermined set speed. It is the application of different cuts of the carcass to which the system and method of the present invention are particularly directed, specifically the auditing of these cuts, the modification of the placement of the cutting blades, and the data accumulated for each cut.

Automation has also played a role in the optimization of meat processing. For example, poultry evisceration and deboning have been successfully automated in commercial settings. Beef and pork carcass automated splitting equipment have been developed for commercial use as well as automated carcass chilling.

As process control is about maintaining appropriate standards throughout production, it is impossible to ignore the role that data capturing it, recording it and interpreting it plays in producing a quality product. Not only can data help to replicate standardized processes, but storing this information also allows for traceability, accountability, and potentially training the processing system for better future results.

Additional optimization through automation via robotics, however, has been limited due to technical challenges. Traditional robotics excels when the task (and all its inputs) are consistent and predictable; for example, picking and placing parts of known size and shape. Animal carcasses and meat subprimals are not so consistent. Both shape and size vary, particularly in larger animals like beef, making the application of robotic automation very challenging.

In the context of meat processing, machine learning and/or artificial intelligence allows the automated system to be responsive to the variation between different carcasses and subprimals. Using AI-driven and machine-learning software, an automated system can not only perceive differences, but also use those perceptions to make decisions about how to act. The use of AI and/or machine learning allows for the automation of tasks that require intelligent decision-making, such as identifying and sorting subprimals or deciding where to trim surface fat on a particular cut of meat.

Artificial intelligence (AI) is a field of study in computer science that develops and studies intelligent machines to simulate human intelligence. Machine learning is a field of study in artificial intelligence at the intersection of computer science and statistics. It focuses on the development of statistical algorithms and models that learn from data and make predictions without explicit instructions.

Meat processors who implement technology driven by enhanced quality control provisions will also achieve greater consistency in product quality. In some instances, even AI and machine leering automation systems can be designed to produce products exactly to specification every time. Such systems will not suffer from fatigue-induced errors or mistakes, providing an opportunity to advance quality assurance and improve profitability.

A state-of-the-art vision-based quality control and audit system is proposed for monitoring the cutting (slaughtering) of carcasses, preferably in a robotic processing system capable of adjustment based on immediate feedback and learning through the implementation of machine learning and artificial intelligence software.

### SUMMARY OF THE INVENTION

Bearing in mind the problems and deficiencies of the prior art, it is therefore an object of the present invention to provide a system and method for monitoring and auditing the processing of animal carcasses that permits robotic stations to perform precise, reliable cuts on suspended carcasses, and to maintain of movement of the processing tool while the carcasses are within an assembly line.

It is another object of the present invention to provide a visual auditing and monitoring system capable of identifying the efficiency and efficacy of each cut of a robotic controlled carcass processing system.

It is another object of the present invention to provide a system and method for monitoring and auditing the processing of animal carcasses, providing information on the relative location of a cut of the supported carcass.

It is yet another object of the present invention to implement corrective actions for prospective cuts of a carcass through machine-learning and/or artificial intelligence attributes.

The above and other objects, which will be apparent to those skilled in the art, are achieved in the present invention which is directed to a method of performing quality control in a carcass cutting process, the method comprising: scanning a surface of cut material of the carcass using at least one visual imaging sensor; obtaining at least one image generated by the scanning, and processing the at least one image to identify variations in material color, depth, and/or surface texture; measuring location and/or extent of the cut material by analyzing color, depth, or surface texture; comparing the at least one image with predetermined data having acceptable values of variations in the material color, depth, and/or surface texture to ascertain quality of the cut material and/or an amount of salient material observed; and reporting results of any comparison to a user.

The method further includes: a) quantitatively measuring color contrast and making an analytical determination as to the amount of color in a designated area; b) quantitatively measuring surface depth and/or texture and making an analytical determination as to the amount of measureable surface depth or texture, respectively; c) determining and recognizing a perimeter and/or outline of a 2-D representation depicted in the at least one image, based either on color contrast, surface texture, or both; d) enhancing recognition of the perimeter and/or outline of the 2-D representation by positioning various environment lighting elements at the carcass; and reporting results includes providing pass/fail criteria to the user.

Wherein the step of processing the at least one image includes identifying a portion of the carcass by quantifying color and/or color contrast from adjacent area surrounding the vertebrae, and validating via geometric shape analysis and inherent location on the carcass.

The geometric shape analysis may include extraction and analysis of object shapes, wherein the geometric shape includes: a) area: number of foreground pixels; b) perimeter: number of pixels in a boundary; c) convex perimeter: a perimeter of a convex hull that encloses the geometric shape; d) roughness: ratio of perimeter to a convex perimeter; e) rectangularity: ratio of the geometric shape to a product of a minimum Feret diameter and a Feret diameter perpendicular to the minimum Feret diameter; f) compactness: ratio of an area of the geometric shape area to an area of a circle with a perimeter of the geometric shape; g) box fill ratio: ratio of the geometric shape area to an area of a bounding box; h) principal axis angle: angle in degrees at which the geometric shape has a least moment of inertia; and i) secondary axis angle: angle perpendicular to a principal axis angle; and any combinations thereof.

Wherein the step of comparing the at least one image with predetermined data having acceptable values of variations may include validating the lumbar based on rectangularity, roughness, area, and distance to carcass centerline.

The method may further include assessing splitting quality of the carcass cutting process symmetrical bisection of feather bones by identifying the feather bones via color or color contrast, distinguishing the feather bones from proximate features on the carcass, and validating the symmetrical bisection through geometric shape analysis, wherein the geometric shape is image-compared to a predetermined shape, and inherent location on the carcass.

Additionally, the method may include taking and storing color imaging and surface topology empirical data, and implementing corrective actions for prospective cuts through machine-learning and/or artificial intelligence attributes.

In a second aspect, the present invention is directed to a method of performing quality control on a carcass cutting process, the method comprising: capturing high-resolution color images at a carcass processing site; using a labeling tool to label all image features of interest, including ham white membrane, vertebrae, Aitch bone, and/or feather bones; randomly splitting the images into training, validation, and test sets with a specified percentage, wherein the specified percentage may be 80%/10%/10% or 70%/15%/15%; using training and validation sets of images to train an AI model, and the test sets to evaluate a final model fit on training images without bias; and after choosing a best algorithm with best tuning and prediction time, deploying the trained AI model within a vision processor controller.

Wherein, when a target enters a workspace of a vision-based sensor system, the method includes: detecting the target by a conveyor switch sensor; triggering a color camera and obtaining at least one frame of a high-resolution color image of the target; transmitting a signal to a vision processor controller of the high-resolution color image; predicting image features existing in the high-resolution color image received; and presenting final audit results based on AI inference outputs interpreted, logged, and sent out to a monitor terminal.

In a third aspect, the present invention is directed to a vision-based quality control system for carcass processing comprising: a mounting bracket in proximity of a carcass rail in a carcass processing facility; at least one visual imaging sensor supported by the mounting bracket and directed at a carcass immediately after an end effector performs a cut on the carcass, the visual imaging sensor capable of distinguishing colors and/or surface texture of a portion of the carcass exposed by the cut; and a processing system controller in electronic communication with the at least one visual imaging sensor, receiving at least one image from the at least one visual imaging sensor, the processing system controller capable of identifying variations in material color and/or texture at a location of the cut, and/or measuring surface area, color, texture, and/or depth of the portion of the carcass exposed by the cut.

Wherein the at least one visual imaging sensor includes a RGB color camera or a RGB-D camera, the RGB-D camera characterizes and quantifies surface topology of the portion of the carcass exposed by the cut, and the processing system controller utilizes machine learning and/or artificial intelligence capabilities to perform comparisons of the cut to prior cuts on other carcasses and provides recommendations for carcass adjustments to a user.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1A depicts a pork carcass supported on a rack with a bisecting cut through the vertebrae, separating the carcass into two sections;

FIG. 1B depicts a close-up view of a ham carcass split into two segments with white membrane visibly indicated on each section of the split carcass;

FIG. 1C depicts an illustration of split carcass segments as captured by the system camera;

FIG. 2 depicts the visual feature of lumbar vertebrae of a split carcass;

FIG. 3 depicts the system-identified vertebra of a split carcass;

FIG. 4 depicts the pork carcass of FIG. 1A with a bisecting cut through marked feather bones;

FIG. 5 depicts the pork carcass of FIG. 1A with the spinal cavity marked in the bisecting cut;

FIG. 6 depicts a cut through a beef portion with an outlining of the Aitch bone;

FIG. 7 depicts a hip bone of a beef loin dropper;

FIG. 8 depicts a backfat region on a carcass, while identifying the rib section;

FIG. 9 depicts an exposed neck bone region of a hog head after a cut;

FIG. 10 depicts a resultant image of the vision-based quality control and audit system where the score is displayed for the operator;

FIG. 11 depicts a top cut edge of a hog head after a cut;

FIG. 12 depicts a process flow chart of an expected cycle of the iterative process;

FIG. 13 graphically depicts a methodology of an illustrious embodiment of the present invention; and

FIG. 14 depicts the placement of the auditing system, located adjacent the moving carcasses, such that the camera is inline with the carcass cut side after the end effector performs a cut.

### DESCRIPTION OF THE PREFERRED EMBODIMENT(S)

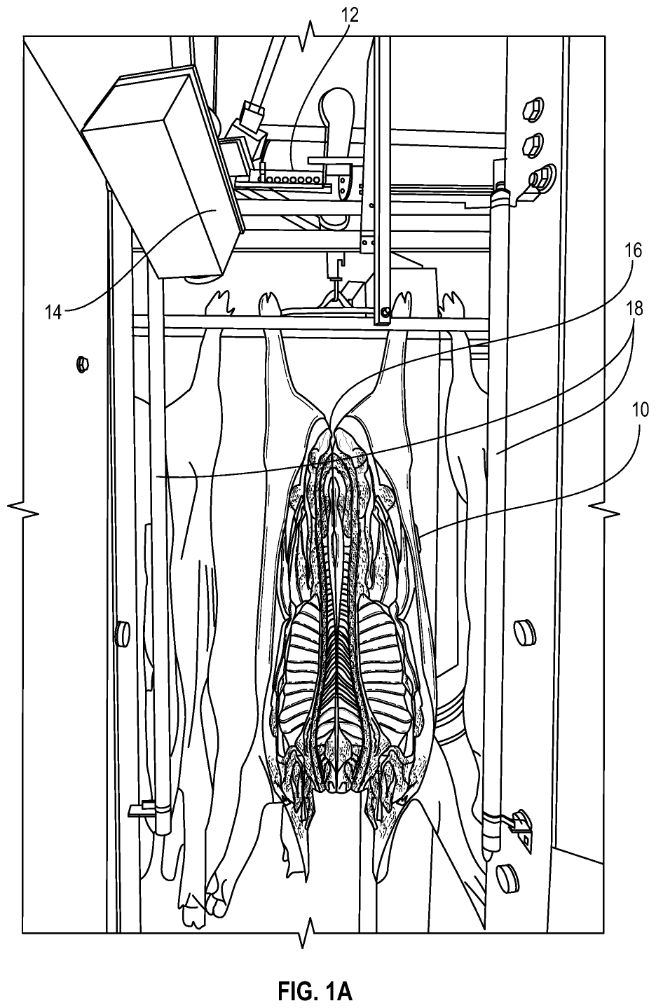

In describing the preferred embodiment of the present invention, reference will be made herein to FIGS. 1-14 of the drawings in which like numerals refer to like features of the invention.

While the present invention is capable of different embodiments in many forms, this specification and the accompanying drawings disclose some specific forms as exemplary embodiments. The invention is not intended to be limited to the embodiments so described.

The present invention relates to a system and method for monitoring and auditing the processing of carcass parts of porcine-, bovine-, ovine-, and caprine-like animals.

The slaughtering of red meat slaughter animals and the subsequent cutting of the carcasses generally takes place in slaughterhouses and/or meat processing plants. Even in relatively modern slaughterhouses and red meat processing plants, many of the processes are performed partly or wholly by hand. This is at least due to variations in the shape, size, and weight of the carcasses and carcass parts to be processed, and to the harsh environmental conditions in the processing areas of slaughterhouses and red meat processing plants. Such manual or semi-automatic machining results in inconsistent cutting, manual rebutting, and costly consumption of labor and time.

To improve robotic products that are dedicated to slaughtering and carcass splitting, and to assist operators in monitoring the quality of automatically or manually processed products, machine vision, artificial intelligence (AI), and data analysis are integrated into robotic carcass processing equipment to develop state-of-the-art vision-based audit system, which may include, for example, employing a single RGB color camera or incorporating a RGB-D camera, or multiple cameras, such as a combination of 2D RGB color camera and 3D depth camera, to a more powerful audit system composed of multiple RGB-D cameras achieving full 3D reconstruction. One such deployment is illustrated in FIG. 1A. As depicted, a ham carcass 10 is shown supported and partially split in half. A conveyor switch sensor 12 is employed to trigger a camera 14, such as a 2D RGB camera. A carcass portion represents the inspection target 16. Machine vision lights 18 define and illuminate the target.

Vision features used in an audit system vary from application to application, and from installation to installation per customer requirements. In at least one embodiment of the present invention, multiple vision features may be utilized simultaneously in a single audit system.

An evaluation of salient quality measurements is required during the monitoring and auditing stages for the system to effectively implement the requisite vision-based corrective features. FIG. 1 A depicts a pork carcass supported on a rack with a bisecting cut through the vertebrae, separating the carcass into two sections As one illustrious example, the splitting quality of the whole carcass as shown in FIG. 1A is evaluated in three distinct portions: 1) the top ham portion from the highest point of the carcass to the middle of the sacral vertebrae; 2) the middle lumbar vertebrae portion from the middle of the sacral vertebrae to the middle of the back bone or approximately 18 to 20 inches down from the highest lumbar vertebrae; and 3) the bottom feather bone portion of the remaining carcass. The observable ham white membrane of a split pork carcass is evaluated to determine if the carcass has been efficiently split into two approximately symmetrical portions, where an approximate equal amount of ham white membrane is experienced on both cut portions. To the extent such observable features are not symmetrically consistent, an adjustment must be made to the cutting blade position.

FIG. 1B depicts a close-up view of a ham carcass 20 split into two segments 22a,b with white membrane visibly indicated on each section of the split carcass. The amount of white membrane 24a,b covering designated surface areas proximate one another are shown in isolated areas 26a, 26b. Either side of the ham 22a,b may be evaluated independently into categories of pass or fail. In this example, there is no symmetry requirement although a symmetry criterion can be implemented if needed to establish more consistent cuts. The ham must be demonstrated to ensure enough white membrane on each split segment with criterion which can be adjustable to specific customer requirements. In this manner, it can be further processed, consistently, such as into cured ham, and hence be given a higher economical value. The white membrane can be identified by color from red lean meat, and from the skin via color or texture. In the example presented by FIG. 1B, an amount white membrane covered surface area is detected by the processing system controller via the auditing system's cameras and a measured portion of the designated surface area is determined, and held to a pass/fail criteria for acceptance. This determination may be achieved by a pixel color quantifier, or an empirically measured surface texture quantifier, or both. Algorithms of either technique may be implemented by the processing system controller. In one embodiment, an image processing pattern matching algorithm is utilized to characterize the surface texture in a comparative nature to other known textures.

Through such measurements, if one side of the ham has sufficient white membrane, but the other side is absent a desired, quantifiable amount, the processing system controller may determine that the blade cut was not ideally positioned, and adjust the cut placement accordingly. Furthermore, through historical data analysis, and the application of machine learning or AI algorithms, it is possible for the system to assist the user/auditor in corrective placement of the carcass, or for the processing apparatus to self-correct based upon information learned from prior cuts.

FIG. 1C depicts an illustration of split carcass segments 28a,b as captured by the system camera, such as, but not limited to, a 12.5 MP color camera. The linear lines 30 form boxes that circumscribe white membrane regions 32a,b. The wavier, non-linear lines 34 form a similar boundary and identify the same white membrane regions 32a,b as determined by a trained AI model. The illustrative example depicts an area of 65852 and 62645 pixels respectively, which can be converted into more intuitive measurement in mm² or inch² via camera calibration.

After the cut, the carcass is inspected optically, preferrably by a visible imaging sensor (such as a camera system) capable of distinguishing the colors and/or surface texture of the carcass exposed by the cut. A visible camera sensor is an imager that collects visible light (typically in the 400 nm-700 nm range) and converts that to an electrical signal, then organizes that information to render images and video streams. Visible cameras utilize these wavelengths of light, which is the same spectrum that the human eye perceives. Visible cameras are designed to create images that replicate human vision, capturing light in red, green and blue wavelengths (RGB) for accurate color representation. This data is electronically converted and stored, and can be processes by a controller, such as a central processing unit (CPU) in the system.

In one embodiment, an RGB color camera is utilized to assist in observing and quantifying the contrasting colors. RGB digital cameras (RGB) compress the spectral information into a trichromatic system capable of approximately representing the actual colors of objects. Although RGB digital cameras follow the same compression philosophy as the human eye (OBS), the spectral sensitivity is different.

Color cameras with depth features, such as an RGB-D camera may be employed for a more enhanced vision of the subject cut features. A depth camera employed in embedded vision applications is advantageous in distinguishing vision features that a two-dimensional construct cannot achieve. RGB-D cameras are a type of depth camera that amplifies the effectiveness of depth-sensing camera systems by enabling object recognition. In this manner, surface topology can be characterized and quantified.

In an alternative embodiment, it is possible to combine a RGB-D camera, or a combination of 2D RGB color cameras, and a 3D depth camera, to accumulate data on the color contrast or surface texture contrast in predetermined, designated, isolated areas to empirically measure the surface area covered by, for example, the white membrane, and determine if there is sufficient white membrane on both split segments. Adjustments may then be made to the cutting tool location for the current carcass and future carcasses.

At least one aspect of the invention is directed to a method for identifying the quality of a cut on a carcass. The method may include scanning the surface of the cut material using at least one camera, preferably a color camera capable of distinguishing color contrast proximate the cut(s). The method obtains at least one image generated by a scan and processes the at least one image to identify variations in the material color and/or surface texture. The method either compares the at least one image with predetermined images to ascertain an object of certain color contrast (and the amount of salient material observed), or a predetermined amount or level of a quantified measure of surface texture. The method may quantitatively measure the color contrast and make an analytical determination as to the amount of color in a designated area, or perform a similar function on surface texture.

The system may include a processor or controller configured to process the at least one image to identify variations in the cut material color and/or texture. The processor can be configured to compare at least one image with predetermined images to ascertain an object of certain color contrast (and the amount thereof), or the level of surface texture.

As will be described in more detail below, image analyzers evaluate images of processing cuts recorded by cameras to recognize and ascertain the quality of the cuts being utilized in carcass processing.

For example, once an image analyzer acquires an image, the system may determine and recognize a perimeter or outline of the 2-D representation depicted in the image, based either on color contrast, surface texture, or both (or other quantifiable attribute that can be recognized and assessed on the exposed surfaces of the cut). Perimeter or outline recognition may be enhanced using various techniques, such as by distinguishing from a background surface that highly contrasts a part depicted in the image, as well as by positioning various environment lighting elements if needed (e.g., full-spectrum light-emitting devices).

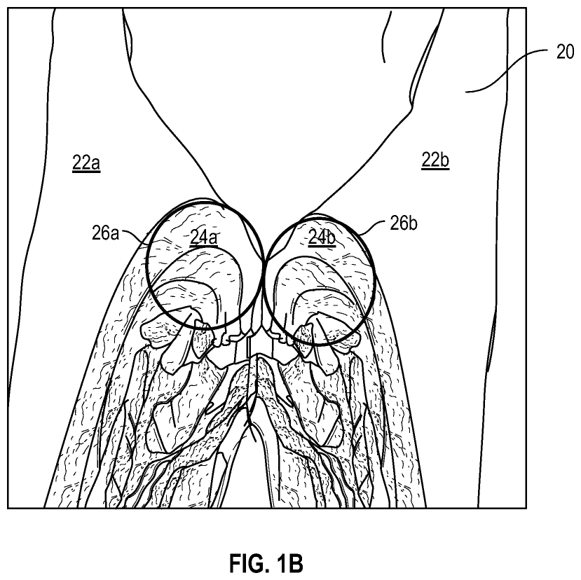

In another example, the lumbar vertebrae of split portions of pork or beef are evaluated via the vision-based auditing system to monitor the effectiveness of the cut. FIG. 2 depicts a pork carcass 40 supported on a rack 42, with a bisecting cut through the vertebrae, separating the carcass into two sections 44a,b. The lumbar vertebrae 46a,b aligned down each section of the carcass can be identified by color and/or color contrast from its adjacent neighborhood and validated through geometric shape analysis and inherent location on the carcass.

Geometric shape analysis in image processing involves the extraction and analysis of object shapes. Possible geometric features of segmented objects may include: a) area: number of foreground pixels; b) perimeter: number of pixels in the boundary; c) convex perimeter: the perimeter of the convex hull that encloses the object; d) roughness: ratio of perimeter to its convex perimeter; e) rectangularity: ratio of the object area to the product of its minimum Feret diameter and the Feret diameter perpendicular to the minimum Feret diameter; f) compactness: ratio of the area of an object to the area of a circle with the same perimeter; g) box fill ratio: ratio of the object area to the area of its bounding box; h) principal axis angle: angle in degrees at which the object shape has the least moment of inertia; and i) secondary axis angle: angle perpendicular to the principal axis angle; and any combinations thereof.

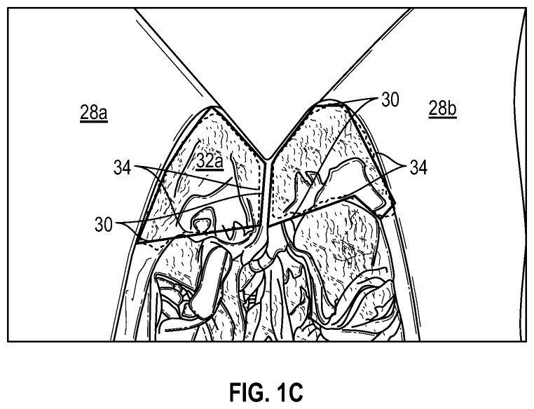

Each identified lumbar vertebrae requires a minimal area and compact shape to be valid. For example, the identified vertebrae in FIG. 3 can be validated based on rectangularity, roughness, area, distance to carcass centerline according to different customers' requirements and needs. Table I depicts quantified values for the different aspects of validation for the illustrated split carcass of FIG. 3.

TABLE I

| Index of | Area | | | Distance to Carcass |
|---|---|---|---|---|
| Identification | (pixel) | Rectangularity | Roughness | Centerline (pixel) |
| 1 | 2648 | 0.75 | 1.16 | 87 |
| 2 | 2382 | 0.78 | 1.16 | 98 |
| 3 | 1892 | 0.73 | 1.14 | 100 |
| 4 | 3729 | 0.84 | 1.1 | 92 |
| 5 | 3999 | 0.78 | 1.21 | 95 |
| 6 | 4137 | 0.81 | 1.16 | 94 |
| 7 | 4119 | 0.83 | 1.11 | 95 |
| 8 | 3550 | 0.88 | 1.07 | 91 |
| 9 | 2465 | 0.59 | 1.13 | 107 |
| 10 | 3532 | 0.62 | 1.13 | 99 |
| 11 | 3690 | 0.61 | 1.19 | 99 |
| 12 | 3936 | 0.8 | 1.12 | 94 |
| 13 | 4218 | 0.83 | 1.11 | 91 |

For each identified image feature in FIG. 3, 51-63, the statistic mean (μ) and standard deviation (σ) can be calculated for a large amount of samples, as depicted in Table II. A general threshold range of valid values is [μ−α*σ, μ+α*σ], where a is a control parameter decided by the user. Common choices for a are typically 3, 2.5, or 2.

TABLE II

| | Area | | | Distance to Carcass |
|---|---|---|---|---|
| | (pixel) | Rectangularity | Roughness | Centerline (pixel) |
| mean (m) | 3407.46 | 0.76 | 1.14 | 95.54 |
| Standard | 783.00 | 0.09 | 0.04 | 5.11 |
| deviation (s) | | | | |

The splitting quality is evaluated by the number of visually consecutive absent or missing lumbar vertebrae. The smaller the number of consecutive absent or missing vertebrae, the better splitting quality achieved. In this manner, a measure of symmetrical bisection can be ascertained by the monitoring and auditing system.

The audit result can be determined as a pass/fail criteria, or if desired, as a quantitative evaluation of the empirical data results from the auditing and monitoring vision-based system, which can be performed by the processing system controller. In one illustrative example, the failure criteria may be the number of consecutive absent vertebrae exceeding a value that is larger than a predetermined amount, such as three consecutive vertebrae undetected by the vision system, exemplifying a misplaced cut.

If the aforementioned failure criteria is met, it would necessitate that the split carcass section be subjected to a manual corrective process, instead of any further automated processing, which would require extra labor and hence cost, or undesirably, the final product without the appealing bone structure, may necessarily be sold at a discounted price.

As noted in the first example, it is possible to acquire empirical data to establish the amount of visible vertebrae associated with each cut, and thereby derive not only the number of vertebrae observed or counted, but also the quality of the cut, in the system's attempt to bisect the vertebrae into two equal components. Along with measurable geometric demarcation, color and surface texture attributes may be quantified and processed for this determination.

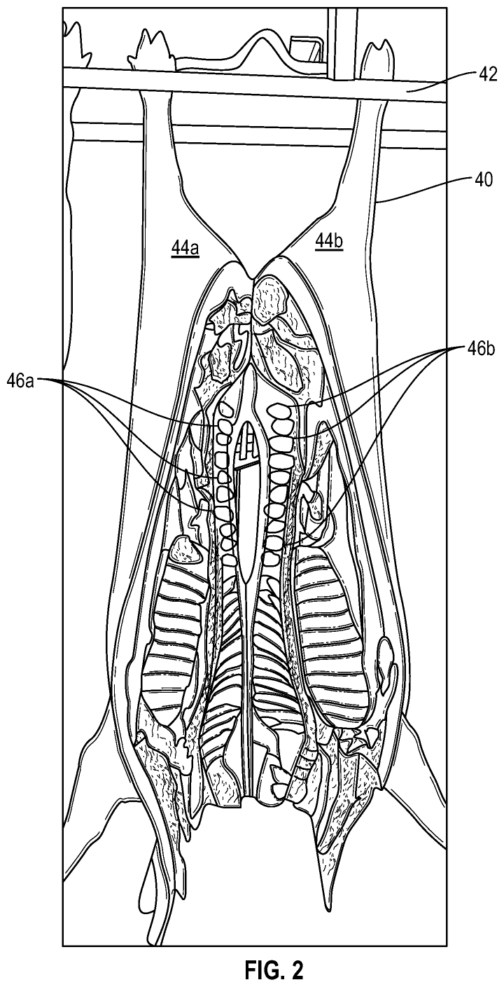

In addition to assessing the clean-cut of the vertebrae, it is also desirable to ascertain the symmetrical bisection of the feather bones. FIG. 4 depicts the pork carcass 40 of FIG. 1A, with a bisecting cut through identified feather bones 49a,b.

Identification of feather bones 49a,b is similar to that of lumbar vertebrae 46a,b. Feather bones may be identified in color as distinguished from their proximate neighborhood, and validated through geometric shape analysis and inherent location on the carcass.

Each identified feather bone requires a predetermined minimal area and identifiable shape to be valid. In this manner, the splitting quality is evaluated by the number of consecutive absent or missing feather bones, such that the smaller the number of consecutive absent feather bones indicates a better splitting quality. The shape, determined in at least one embodiment, may also be image-compared to predetermined shapes.

In one embodiment, the audit result of a feather bone analysis may be designated as either pass or fail. The failure criterion may be that the number of consecutively visually absent feather bones larger than a predetermined threshold, e.g., three consecutive visually absent feather bones. The failure mode may also be designated by not having a comparative acceptable image of the bone shape after the cut.

As noted previously, if the aforementioned failure criteria is met, it would necessitate that the split carcass section be subjected to a manual corrective process, instead of further automated processing, which would require extra labor and hence cost, or undesirably, the final product without the appealing bone structure, must be sold at a discounted price.

As noted in the prior examples, it is possible to acquire empirical data to establish the amount of visible feather bones associated with each cut, and thereby derive not only the number of feather bones observed and/or counted, but also the quality of the cut in its attempt to bisect each feather bone into two equal segments. Along with measurable geometric demarcation, color and surface texture attributes may be quantified and processed for this determination.

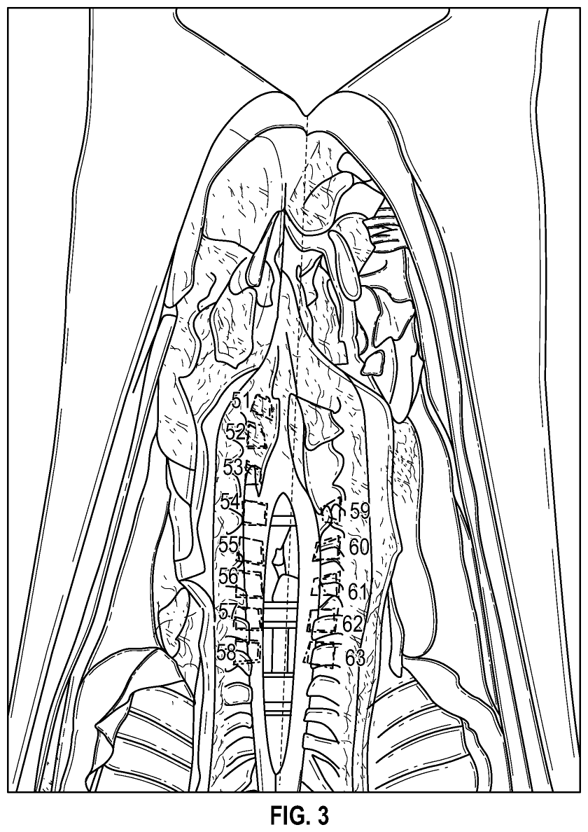

FIG. 5 depicts the pork carcass 40 of FIG. 1A, with the spinal cavity 70 identified in the bisecting cut. The spinal cavity 70 is identified via color proximate its adjacent neighborhood. From the color demarcation of the vision-based auditing system, the spinal cavity geometric continuity may be empirically determined. Preferably, the spinal cord is split completely and all the spinal cavity is visible. This determination will help facilitate federal inspection requirements. In one embodiment, there may be no symmetry requirement between the left and right spinal cavity. The vision-based audit result may be either pass or fail. A failed product with partially or completely invisible spinal cavity requires extra manual processing to expose the spine cavity completely. In other embodiments, symmetry may be utilized as pass/fail criteria.

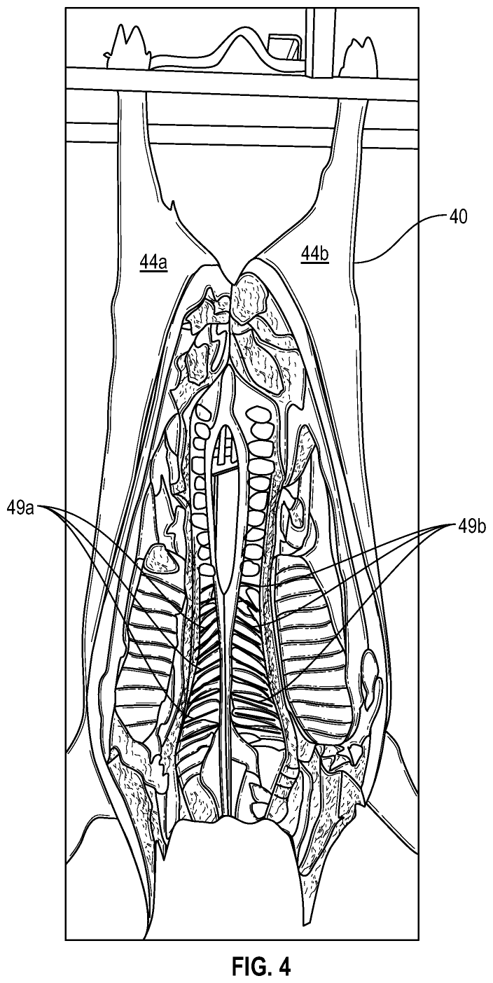

The Aitch bone is another quality control point for a pork or beef splitter, or beef loin dropper. The Aitch bone is the buttock or rump bone. FIG. 6 depicts a cut through a beef portion 72, with an outlining of the Aitch bone 74. Utilizing any embodiment of the vision-based quality control and audit system of the present invention, the Aitch bone may be identified via a combination of color and 3D shape variations utilizing machine learning and AI technology. Color imaging and surface topology empirical data is taken and stored, and invariably used for assessment of the cut, and through machine-learning attributes, corrective actions are implemented for prospective cuts.

In one embodiment, the lower edge of the Aitch bone can be used as a reference point to separate the loin from the leg part (pork fresh ham or beef round). An audit criterion may be whether the cut surface has a proper and consistent distance from the reference point on the edge of the Aitch bone to achieve acceptable meat quality and result in a more economical cut. Empirical results obtained by the process controller can be used to ascertain the cut quality.

The Aitch bone may also be used as a secondary feature in carcass splitting. If the Aitch bone can be identified on each half of the split carcass, and have predetermined proper geometric shape, the splitting at the leg part will be judged a better quality.

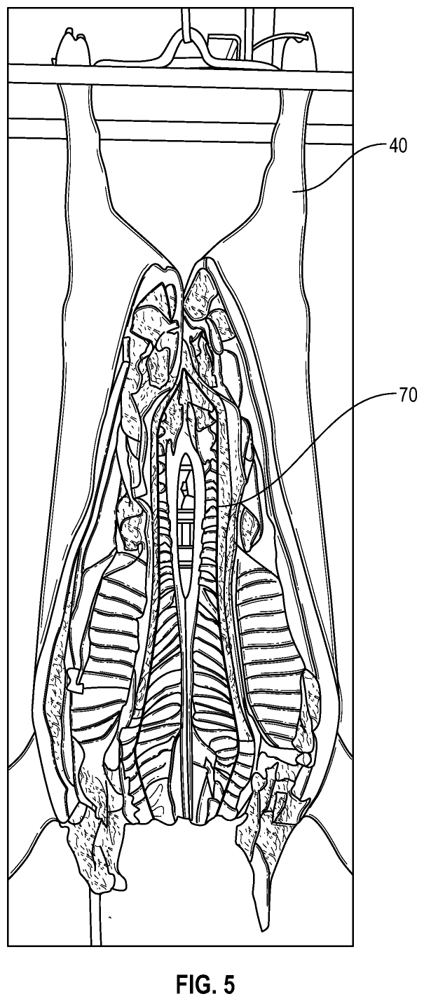

FIG. 7 depicts a hip bone 76 of a beef loin dropper 78. Implementation of the vision-based quality control and audit system is performed in a similar manner as that described above for the quality measurements for other cuts. The cut surface of the hip bone 76 is identified via color, and is validated in geometric shape, particularly the diameter. In one embodiment, the audit criterion is whether the cut cross section of the bone has a proper shape and size so that the cut separation is at the ideal location to achieve acceptable meat quality of the final products.

In yet another embodiment, visually monitoring and auditing the backfat thickness of a carcass can also assist in determining the quality of the carcass, as well as the determination of a clean, accurate cut. Backfat assessment assists in predicting lean meat yield and the eating quality of meat, and hence is useful for trading the animals fairly between different meat processing parties.

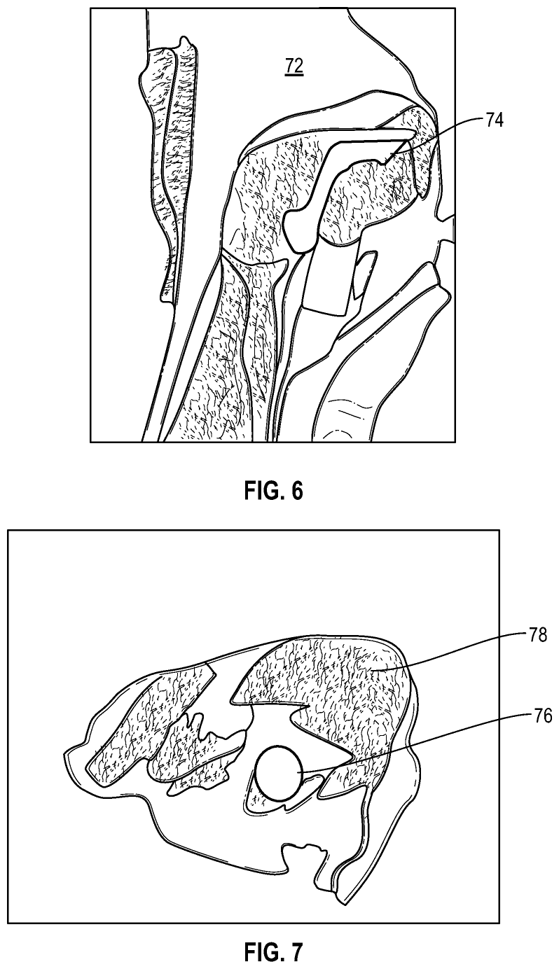

Backfat thickness over the last rib is an important criterion of carcass grading. Generally, it is observable via color difference from the feather bones and the background. The thinner the backfat, the higher carcass grade is realized given other similar evaluation parameters. FIG. 8 depicts a backfat region 80 on a carcass 82, while identifying the rib section R1-R14.

In this embodiment, the vision-based quality control and audit system utilizes the color contrast to identify the backfat, and measurements of the image via software determines the backfat thickness. Based on predetermined criteria for optimal thickness, the system determines if the cut is acceptable, or if further processing is warranted, or a readjustment of the blade is needed.

The grades of barrow and gilt carcass are generally identified as follows:
U.S. No. 1: less than 1.00 inch with average muscling, or less than 1.25 inches with thick muscling;
U.S. No. 2: 1.00 to 1.24 inches with average muscling, 1.25 to 1.49 inches with thick muscling, less than 1.00 inch with thin muscling;
U.S. No. 3: 1.25 to 1.49 inches with average muscling, 1.50 to 1.74 inches with thick muscling, 1.00 to 1.24 inches with thin muscling; and
U.S. No. 4: 1.50 inches or greater with average muscling, 1.75 inches or greater with thick muscling, 1.25 inches or greater with thin muscling.

Furthermore, beef fat thickness at the 12th rib has a normal range of 0.15-0.8 inches with an average of 0.5 inches.

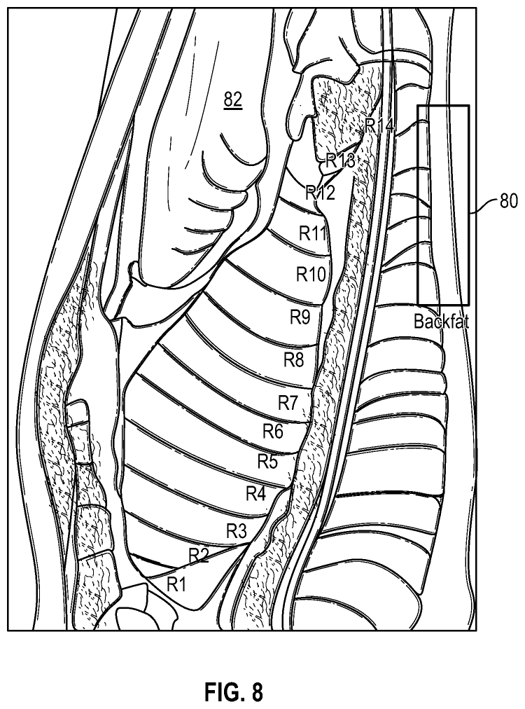

In another application, the vision-based quality control and audit system can be used for a pork head dropper to assess the proper cut for the neck bone. FIG. 9 depicts an exposed neck bone region 84 of a hog head 86 after a cut. Exposed neck bone region 84 presents a unique color contrast and textual pattern that can be used in the image processing pattern matching algorithm. One applicable audit criterion is to assign a pattern matching score based on comparing the image taken to known patterns in a predetermined database.

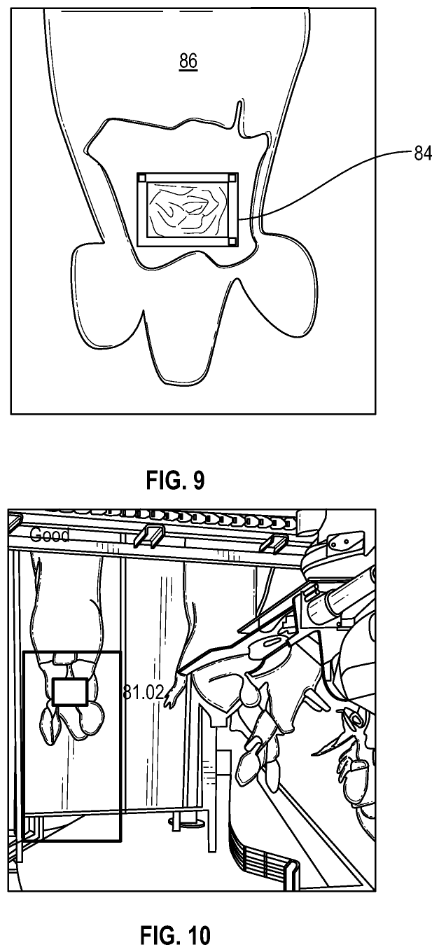

A pattern matching score is assigned, and varies from 0 to 100. A high score indicates a very close matching, while a low score indicates a poor matching. For exemplary purposes, FIG. 10 depicts a resultant image of the vision-based quality control and audit system where the score is displayed for the operator. In this example, a score of 81.02 was calculated, and the matched pattern location is indicated by the yellow box.

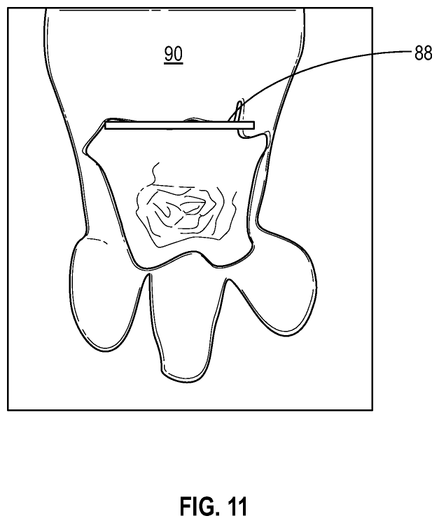

The edge of the cut from a pork head dropper can also be ascertained to ensure a precise location of the cut. FIG. 11 depicts a top cut edge 88 of hog head 90 after a cut. The top cut edge 88 can be determined by detecting color contrast or intensity discontinuity. This additional measurement in a head dropper application is used to calculate the dropping cavity with reference to the pattern of the matching neck bone region.

In the aforementioned examples, the vision-based monitoring and auditing system accumulates data on the efficacy of each cut. From such data, the processing system can be adjusted for the next cut, and retain this information for future cuts, such that the processing system learns to adjust based on historically acquired data sets.

A sample method of operation of an embodiment of the auditing system of the present invention may include the following steps:
a) Capture high-resolution color images (which could be as many as several thousand) at a customer site;
b) Use a labeling tool to label all image features of interest such as ham white membrane, vertebrae and feather bones;
c) Randomly split the images into training, validation, and test sets with a specified percentage such as 80%/10%/10% or 70%/15%/15%;
d) Use training and validation sets of images to train an AI model and the test set of images to evaluate the final model fit on the training images without bias; and
e) After choosing the best algorithm with best tuning and prediction time, deploy the trained AI model onto the vision processor controller. When a target enters the vision-based system's workspace and is detected by the conveyor switch sensor, a color camera is triggered and one frame of high-resolution color image of the target is obtained and transmitted to the vision processor controller. The pre-trained AI model makes predictions of image features existing in the received color image, and final audit results based on AI inference outputs are interpreted, logged, and sent out to the monitor terminal.

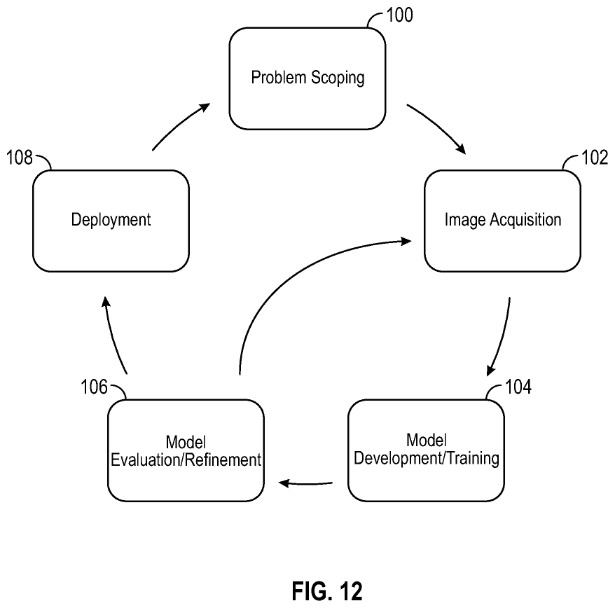

An AI-based method of quality control and audit is typically an iterative process that incrementally delivers a better solution. FIG. 12 depicts a process flow chart of an expected cycle of the iterative process. Problem Scoping 100 defines the problem to be solved using AI, Image Acquisition 102 involves capturing sample images from the customer facilities, and Model Development/Training 104 involves labeling captured images and developing the AI models. The developed AI model is subject to Model Evaluation/Refinement 106, and is deployed 108 if the achievable performance meets the customer requirements; otherwise the system delves into Image Acquisition 102 for more images to build a new AI model. Once an AI model is deployed 108 and solves real-world problems, the cycle repeats at Problem Scoping 100 so that a better solution can be developed.

The software architecture is capable of supporting software packages such as TensorFlow and PyTorch deep learning frameworks, and utilize all popular AI models, including ResNet, CenterNet, Faster R-CNN, and Yolo.

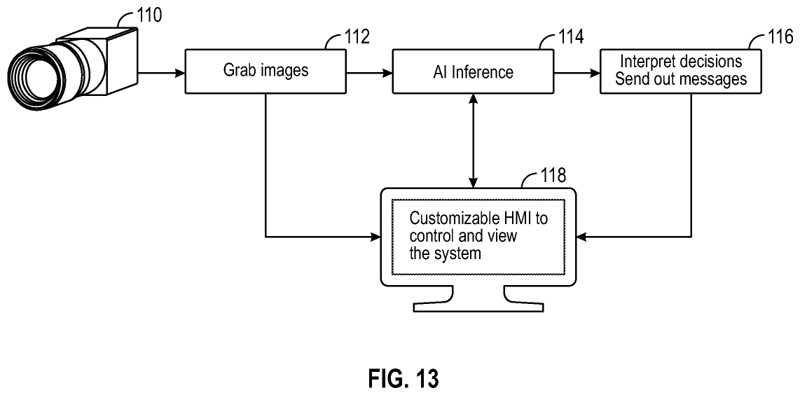

FIG. 13 graphically depicts a methodology of an illustrious embodiment of the present invention. A camera 110 is used to grab images 112 of the cut carcass. AI inferences 114 are applied to the captured images, and are empirically interpreted 116. Customized output 118 to a terminal allows a user or auditor to view the system results.

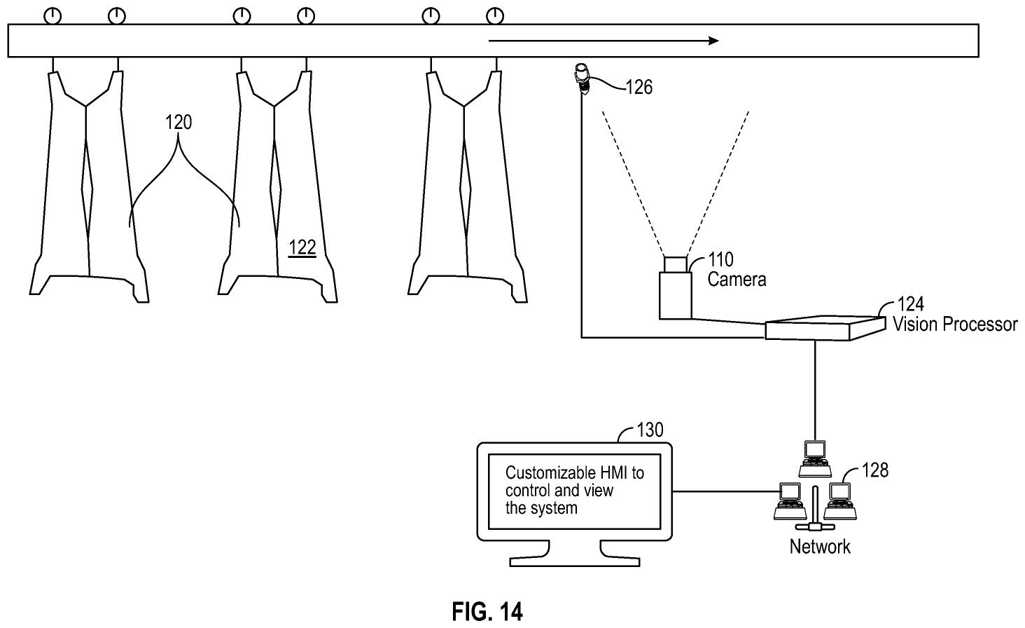

FIG. 14 depicts the placement of the auditing system, located adjacent the moving carcasses 120, such that camera 110 is inline with the carcass cut side 122 after the end effector performs a cut. Camera 110 is controlled by a vision processor 124, which receives feedback from sensor 126. Vision process 124 may connect directly to a network 128, and the output signal may be within a customized HMI format 130 to allow the user to control and view the system.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of performing quality control in a carcass cutting process, said method comprising:
scanning a surface of cut material of said carcass using at least one visual imaging sensor;
obtaining at least one image generated by said scanning, and processing the at least one image to identify variations in material color, depth, and/or surface texture;
measuring location and/or extent of said cut material by analyzing color, depth, or surface texture;
comparing the at least one image with predetermined data having acceptable values of variations in said material color, depth, and/or surface texture to ascertain quality of said cut material and/or an amount of salient material observed; and
reporting results of any comparison to a user.

2. The method of claim 1 including quantitatively measuring color contrast and making an analytical determination as to the amount of color in a designated area.

3. The method of claim 1 including quantitatively measuring surface depth and/or texture and making an analytical determination as to the amount of measureable surface depth or texture, respectively.

4. The method of claim 1 wherein said step of reporting results includes providing pass/fail criteria to said user.

5. The method of claim 1 including determining and recognizing a perimeter and/or outline of a 2-D representation depicted in said at least one image, based either on color contrast, surface texture, or both.

6. The method of claim 5 including enhancing recognition of said perimeter and/or outline of said 2-D representation by positioning various environment lighting elements at said carcass.

7. The method of claim 1 wherein said step of processing said at least one image includes identifying a portion of said carcass by quantifying color and/or color contrast from adjacent area surrounding said vertebrae, and validating via geometric shape analysis and inherent location on said carcass.

8. The method of claim 7 wherein said portion of said carcass includes lumbar vertebrae aligned down each section of said carcass.

9. The method of claim 7 wherein said geometric shape analysis includes extraction and analysis of object shapes, wherein said geometric shape includes: a) area: number of foreground pixels; b) perimeter: number of pixels in a boundary; c) convex perimeter: a perimeter of a convex hull that encloses said geometric shape; d) roughness: ratio of perimeter to a convex perimeter; e) rectangularity: ratio of said geometric shape to a product of a minimum Feret diameter and a Feret diameter perpendicular to said minimum Feret diameter; f) compactness: ratio of an area of said geometric shape area to an area of a circle with a perimeter of said geometric shape; g) box fill ratio: ratio of said geometric shape area to an area of a bounding box; h) principal axis angle: angle in degrees at which said geometric shape has a least moment of inertia; and i) secondary axis angle: angle perpendicular to a principal axis angle; and any combinations thereof.

10. The method of claim 8 wherein said step of comparing the at least one image with predetermined data having acceptable values of variations includes validating said lumbar based on rectangularity, roughness, area, and distance to carcass centerline.

11. The method of claim 1 including assessing splitting quality of said carcass cutting process by quantifying a number of visually consecutive absent or missing lumbar vertebrae, such that a smaller the number of said consecutive absent or missing vertebrae results in a higher splitting quality achieved.

12. The method of claim 1 including assessing splitting quality of said carcass cutting process symmetrical bisection of feather bones by identifying said feather bones via color or color contrast, distinguishing said feather bones from proximate features on said carcass, and validating said symmetrical bisection through geometric shape analysis, wherein said geometric shape is image-compared to a predetermined shape, and inherent location on said carcass.

13. The method of claim 12 wherein each identified feather bone requires a predetermined minimal area and identifiable shape to be valid.

14. The method of claim 1 including empirically determining spinal cavity geometric continuity of said carcass cutting process.

15. The method of claim 1 including identifying an Aitch bone via a combination of color and 3D shape variations utilizing machine learning and AI technology.

16. The method of claim 15 including taking and storing color imaging and surface topology empirical data, and implementing corrective actions for prospective cuts through machine-learning and/or artificial intelligence attributes.

17. The method of claim 1 including visually monitoring and auditing the backfat thickness of said carcass.

18. The method of claim 1 including assessing a proper cut for a neck bone via color contrast, textual pattern, and/or intensity discontinuity in an image.

19. The method of claim 18 including assigning a pattern matching score based on comparing an image taken to known patterns in a predetermined database.

20. A method of performing quality control on a carcass cutting process, said method comprising:
capturing high-resolution color images at a carcass processing site;
using a labeling tool to label all image features of interest, including ham white membrane, vertebrae, Aitch bone, and/or feather bones;
randomly splitting the images into training, validation, and test sets with a specified percentage, wherein the specified percentage may be 80%/10%/10% or 70%/15%/15%;
using training and validation sets of images to train an AI model, and said test sets to evaluate a final model fit on training images without bias; and
after choosing a best algorithm with best tuning and prediction time, deploying the trained AI model within a vision processor controller.

21. The method of claim 20, wherein, when a target enters a workspace of a vision-based sensor system, said method includes:
detecting said target by a conveyor switch sensor;
triggering a color camera and obtaining at least one frame of a high-resolution color image of the target;
transmitting a signal to a vision processor controller of said high-resolution color image;
predicting image features existing in said high-resolution color image received; and
presenting final audit results based on AI inference outputs interpreted, logged, and sent out to a monitor terminal.

22. A vision-based quality control system for carcass processing comprising:
a mounting bracket in proximity of a carcass rail in a carcass processing facility;
at least one visual imaging sensor supported by said mounting bracket and directed at a carcass immediately after an end effector performs a cut on said carcass, said visual imaging sensor capable of distinguishing colors and/or surface texture of a portion of said carcass exposed by said cut; and
a processing system controller in electronic communication with said at least one visual imaging sensor, receiving at least one image from said at least one visual imaging sensor, said processing system controller capable of identifying variations in material color and/or texture at a location of said cut, and/or measuring surface area, color, texture, and/or depth of said portion of said carcass exposed by said cut.

23. The vision-based quality control system of claim 22 wherein said at least one visual imaging sensor includes a RGB color camera or a RGB-D camera.

24. The vision-based quality control system of claim 23 wherein said RGB-D camera characterizes and quantifies surface topology of said portion of said carcass exposed by said cut.

25. The vision-based quality control system of claim 24 including multiple cameras, such as a combination of a 2D RGB color camera and 3D depth camera.

26. The vision-based quality control system of claim 22 wherein said at least one visual imaging sensor includes multiple RGB-D cameras achieving full 3D reconstruction.

27. The vision-based quality control system of claim 22 wherein said processing system controller utilizing machine learning and/or artificial intelligence capabilities performs comparisons of said cut to prior cuts on other carcasses and provides recommendations for carcass adjustments to a user.

28. The vision-based quality control system of claim 22 wherein said processing system controller measures an amount of white membrane covered surface area via the at least one visual imaging sensor and a portion of the surface area is held to a pass/fail criteria for acceptance.

29. The vision-based quality control system of claim 22 wherein said at least one visual imaging sensor transmits a signal to said processing system controller identifying a pixel color quantifier, or an empirically measurable surface texture quantifier, or both.

30. The vision-based quality control system of claim 23 including a conveyor switch sensor employed to trigger said camera.

31. The vision-based quality control system of claim 22 including machine-vision lights to define and illuminate a target area.

32. The vision-based quality control system of claim 22 wherein said carcass rail includes a plurality of trolleys spaced at desired intervals and movable along the carcass rail, each trolley capable of supporting a beef carcass.
